(19) United States
(12) Patent Application Publication
(10) Pub. No.: US 2021/0283845 A1
(43) Pub. Date: Sep. 16, 2021

(54) FILAMENT MANUFACTURING DEVICE AND SHAPING APPARATUS

(71) Applicant: FUJIFILM BUSINESS INNOVATION CORP., Tokyo (JP)

(72) Inventor: Kentaro AGEISHI, Kanagawa (JP)

(73) Assignee: FUJIFILM BUSINESS INNOVATION CORP., Tokyo (JP)

(21) Appl. No.: 16/985,287

(22) Filed: Aug. 5, 2020

(30) Foreign Application Priority Data
Mar. 10, 2020 (JP) 2020-041400

(51) Int. Cl. B29C 64/314; D01H 7/02; D01H 13/28; D06M 15/19; B33Y 30/00; B33Y 40/10; B33Y 50/02; B29C 64/393; B29B 15/14

(52) U.S. Cl. CPC B29C 64/314; D01H 7/02; D01H 13/28; D06M 15/19; B29K 2307/04; B33Y 40/10; B33Y 50/02; B29C 64/393; B29B 15/14; B33Y 30/00

(57) ABSTRACT

A filament manufacturing device includes an impregnation unit and a twisting unit. The impregnation unit is configured to impregnate a bundle of transported continuous fibers with a resin so as to form a filament. The twisting unit is configured to twist the filament downstream of the impregnation unit in a transport direction in which the bundle of continuous fibers is transported, so as to form the twisted filament.

### CROSS-REFERENCE TO RELATED APPLICATIONS

This application is based on and claims priority under 35 USC 119 from Japanese Patent Application No. 2020-041400 filed Mar. 10, 2020.

### BACKGROUND

### 1. Technical Field

The present disclosure relates to a filament manufacturing device and a shaping apparatus.

### 2. Related Art

JP-A-2019-81292 discloses a three-dimensional object manufacturing apparatus that manufactures a three-dimensional object by arranging a filament containing a fiber and a resin material continuous in a longitudinal direction. The three-dimensional object manufacturing apparatus includes a holder on which the filament is provided and a filament supply unit that supplies the filament to the holder. The filament supply unit includes a twisting unit that twists the filament about a first axis extending in the longitudinal direction.

### SUMMARY

Aspects of non-limiting embodiments of the present disclosure relate to providing a filament manufacturing device capable of manufacturing a twisted filament formed by twisting a bundle of continuous fibers impregnated with a resin.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a filament manufacturing device including an impregnation unit and a twisting unit. The impregnation unit is configured to impregnate a bundle of transported continuous fibers with a resin so as to form a filament. The twisting unit is configured to twist the filament downstream of the impregnation unit in a transport direction in which the bundle of continuous fibers is transported, so as to form the twisted filament.

### BRIEF DESCRIPTION OF THE DRAWINGS

Exemplary embodiment(s) of the present disclosure will be described in detail based on the following figures, wherein:

FIG. 1 is a schematic configuration view showing a shaping apparatus according to an exemplary embodiment;

FIG. 2 is a schematic configuration view showing an untwisting unit according to the exemplary embodiment;

FIG. 3 is a schematic configuration view showing one of impregnation units according to the exemplary embodiment;

FIG. 4 is a schematic configuration view showing one of twisting units according to the exemplary embodiment; and

FIG. 5 is a plan view showing a U-shaped portion of a three-dimensional object shaped by the shaping apparatus according to the exemplary embodiment.

### DETAILED DESCRIPTION

### Exemplary Embodiment

First, an example of a filament manufacturing device and a shaping apparatus according to a first exemplary embodiment of the present disclosure will be described with reference to the drawings. An arrow H shown in the drawing indicates an apparatus upper-lower direction (vertical direction), an arrow W indicates an apparatus width direction (horizontal direction), and an arrow D indicates an apparatus depth direction (horizontal direction).

### (Shaping Apparatus 10)

A shaping apparatus 10 is a fused deposition modeling (FDM) three-dimensional shaping apparatus (that is, a 3D printer). The shaping apparatus 10 is an apparatus that shapes a three-dimensional object by stacking plural layers in accordance with layer data of the plural layers.

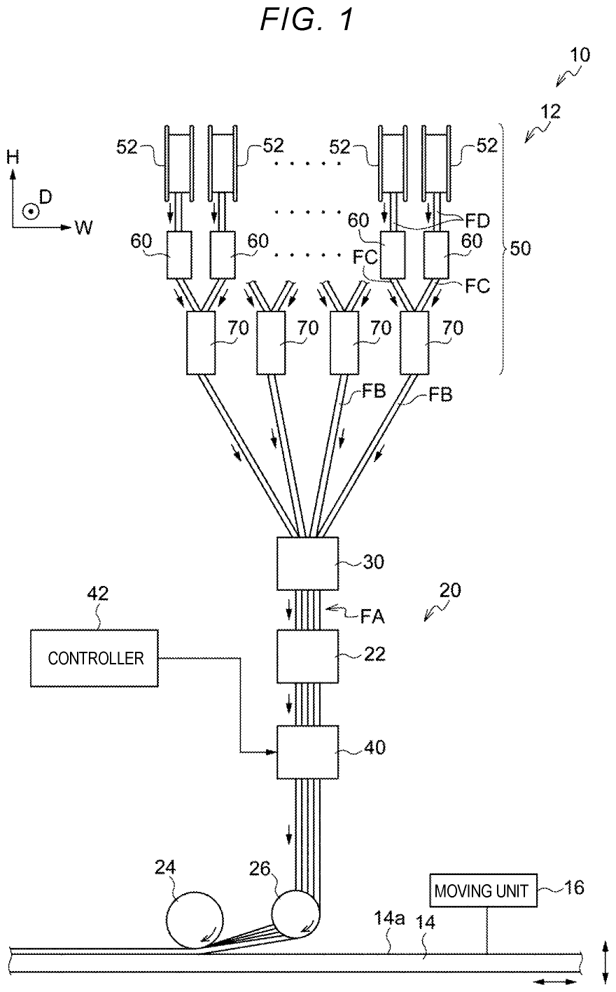

As shown in FIG. 1, the shaping apparatus 10 includes a shaping unit 12, a base 14, and a moving unit 16. The base 14 is disposed below the shaping unit 12. The base 14 includes a surface 14a which is a horizontal surface facing upward. The shaping unit 12 forms a layer by applying a parallel filament FA on the surface 14a of the base 14 as a shaping material, and stacks the plural layers to shape a three-dimensional object. The parallel filament FA is formed by arranging four twisted filaments FB (which will be described later) in parallel. The surface 14a is an example of an applied surface. An operation of each component of the shaping apparatus 10 is controlled by an overall controller (not shown) in accordance with three-dimensional data of the three-dimensional object.

The moving unit 16 relatively moves the shaping unit 12 with respect to the base 14. That is, the shaping unit 12 is moved relatively with respect to the surface 14a by the moving unit 16 along the surface 14a of the base 14. The shaping unit 12 is moved relatively with respect to the surface 14a by the moving unit 16 along a stacking direction. In the exemplary embodiment, the moving unit 16 includes an actuator that moves the base 14 in the apparatus upper-lower direction, the apparatus width direction, and the apparatus depth direction. The moving unit 16 may move the shaping unit 12.

### (Shaping Unit)

The shaping unit 12 includes four filament manufacturing devices 50 and an applying unit 20. In the exemplary embodiment, the filament manufacturing devices 50 and the applying unit 20 are provided in order from above. The filament manufacturing devices 50 manufacture the four twisted filaments FB which will form the parallel filament FA, and transport the twisted filaments FB toward the applying unit 20. The applying unit 20 applies the parallel filament FA formed by the four twisted filaments FB transported from the filament manufacturing devices 50 toward the surface 14a of the base 14 that is moved relative to the applying unit 20 by the moving unit 16. A direction in which the applying unit 20 is relatively moved with respect to the surface 14a of the base 14 is a direction intersecting a direction in which the twisted filaments FB forming the parallel filament FA are arranged in parallel. The filament manufacturing device 50 will be described in detail later.

### (Applying Unit)

The applying unit 20 includes a parallel transport unit 30, a filament heating unit 22, an untwisting unit 40, a controller 42, an angle change roller 26, and a pressure roller 24. In the exemplary embodiment, the parallel transport unit 30, the filament heating unit 22, the untwisting unit 40, the angle change roller 26, and the pressure roller 24 are sequentially arranged in order from an upstream in a transport direction of the parallel filament FA. The parallel transport unit 30 arranges the four twisted filaments FB transported from the filament manufacturing devices 50 in parallel so as to form the parallel filament FA, and transports the parallel filament FA toward the untwisting unit 40. The parallel transport unit 30 is an example of a transport unit. The filament heating unit 22 is a heating device such as a heater. The filament heating unit 22 heats the parallel filament FA transported from the parallel transport unit 30 to the untwisting unit 40. The untwisting unit 40 untwists the four twisted filaments FB forming the parallel filament FA transported from the parallel transport unit 30, separately, and sends the parallel filaments FA toward the surface 14a of the base 14. The controller 42 is electrically connected to the untwisting unit 40. The controller 42 controls an amount of untwisting by which the untwisting unit 40 untwists the twisted filaments FB, in accordance with shaping process data that is based on the three-dimensional data of the three-dimensional object. Details of the untwisting unit 40 and the controller 42 will be described later.

The pressure roller 24 presses and applies the parallel filament FA sent from the untwisting unit 40, toward the base 14.

The angle change roller 26 is provided between the untwisting unit 40 and the pressure roller 24. The angle change roller 26 changes an angle a between the parallel filament FA sent from the untwisting unit 40 to the pressure roller 24 and the surface 14a of the base 14, to an acute angle. The angle α is changed by the angle change roller 26 to, for example, 15° or larger and 45° or smaller.

### (Filament Manufacturing Device)

Each of the filament manufacturing devices 50 includes two supply units 52, two impregnation units 60, and one twisting unit 70. That is, the shaping apparatus 10 according to the exemplary embodiment includes eight supply units 52, eight impregnation units 60, and four twisting units 70. In the exemplary embodiment, the supply units 52, the impregnation units 60, and the twisting units 70 are arranged in order from above.

The supply units 52 are two reels on which, for example, fiber bundles FD are wound. Each supply unit 52 supplies the fiber bundle FD to a respective one of the impregnation units 60 from a respective one of the reels. The fiber bundle FD is an example of a bundle of continuous fibers. The continuous fiber is, for example, a carbon fiber having a diameter of 0.007 mm. The fiber bundle FD is formed by bundling, for example, 3000 carbon fibers into a circular shape having a diameter of 0.4 mm. In the exemplary embodiment, the reel of the supply unit 52 is detachable from the shaping apparatus 10 and replaceable with another reel.

### (Impregnation Unit)

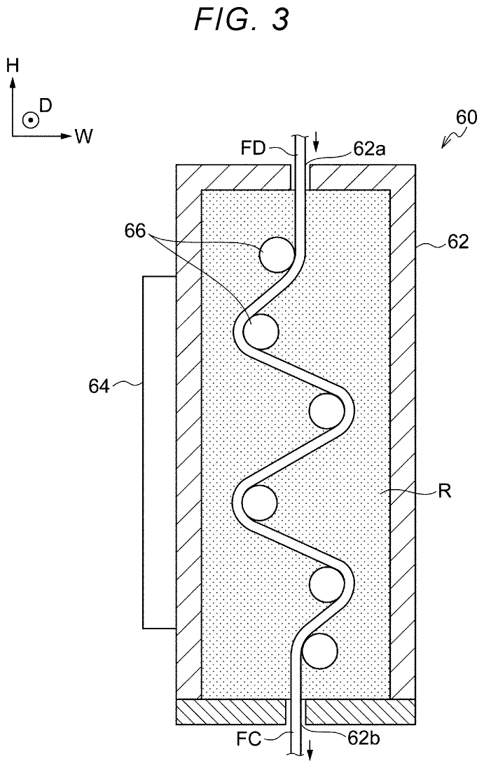

As shown in FIG. 3, the impregnation unit 60 includes a body 62, a resin heating unit 64, and an impregnation roller group 66. The body 62 is, for example, a container extending in a transport direction of the fiber bundle FD. Specifically, the body 62 includes a pair of end walls that intersecting the transport direction of the fiber bundle FD, and a side wall extending in the transport direction of the fiber bundle FD and connecting peripheral portions of the pair of end walls. The body 62 accommodates a resin R in a molten state inside. A filament FC is formed by impregnating the fiber bundle FD supplied from the supply unit 52 with the resin R. In the exemplary embodiment, the continuous fibers forming the filament FC and the fiber bundle FD each extend linearly along a continuous direction of the fiber bundle FD. In other words, in the exemplary embodiment, the filament FC and the fiber bundle FD themselves do not have a twist.

The body 62 includes a receiving port 62a and a delivery port 62b. The body 62 receives the fiber bundle FD supplied from the supply unit 52 through the receiving port 62a. The filament FC formed inside the body 62 is sent out from the body 62 toward the twisting unit 70 through the delivery port 62b. The resin heating unit 64 is a heating device such as a heater provided on a side wall of the body 62. The resin heating unit 62 heats and melts the resin R accommodated in the body 62. The resin R is supplied to the body 62 from a resin supply unit (not shown).

### (Impregnation Roller Group)

The impregnation roller group 66 is plural roller members arranged inside the body 62 in a zigzag shape extending in the transport direction of the fiber bundle FD. The impregnation roller group 66 opens the fiber bundle FD transported in the body 62 from the receiving port 62a toward the delivery port 62b, and facilitates impregnation of the fiber bundle FD with the resin R. The impregnation roller group 66 is an example of an opening unit. The impregnation roller group 66 binds the fiber bundle FD impregnated with the resin R in an opened state as transporting the fiber bundle FD, and then guides the filament FC to the delivery port 62b to transport the filament FC toward the twisting unit 70.

### (Twisting Unit)

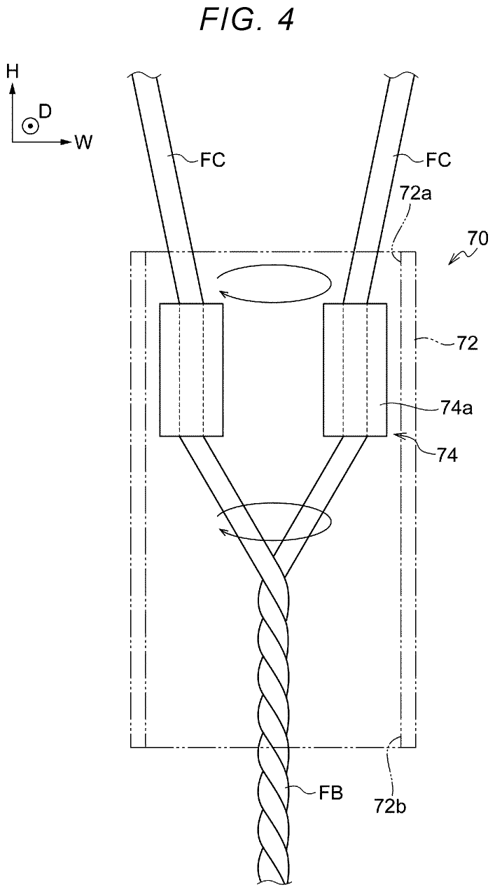

As shown in FIGS. 1 and 4, the twisting unit 70 twists two filaments FC transported from the pair of impregnation units 60 to form the twisted filament FB, and transports the twisted filament FB toward the applying unit 20. In the exemplary embodiment, the twisted filaments FB are transported to the parallel transport unit 30 of the applying unit 20. In the twisted filament FB according to the exemplary embodiment, the two filaments FC are twisted in a spiral shape with each other so as to have a twist. When the two filaments FC form the twisted filament FB, the continuous fibers forming the filaments FC are twisted in a spiral shape in the same manner as the filament FC so as to have a twist. As shown in FIG. 4, the twisting unit 70 includes a body 72 and a twisting mechanism 74.

The body 72 is, for example, a cylindrical member extending in the transport direction of the fiber bundle FD. The body 72 includes a receiving port 72a at an upstream end portion in the transport direction and a delivery port 72b at a downstream end portion in the transport direction. The body 72 receives the filament FC transported from the impregnation unit 60 through the receiving port 72a. The twisted filament FB formed inside the body 72 is sent out toward the untwisting unit 40 through the delivery port 72b.

The twisting mechanism 74 includes a pair of through tubes 74a. The through tubes 74a are cylindrical members that are provided inside the body 72. The through tubes 74a extend in the transport direction of the fiber bundle FD. The through tubes 74a are arranged in a direction intersecting the transport direction. Each of the two filaments FC transported from the pair of impregnation units 60 and received through the receiving port 72a is passed inside a corresponding one of the through tubes 74a. The twisting mechanism 74 transports the filaments FC while rotating the pair of through tubes 74a through which the filaments FC are passed about a center axis of the body 72 using a motor (not shown), so as to twist the filaments FC downstream of the through tubes 74a in the transport direction. Accordingly, the twisting mechanism 74 forms the twisted filament FB from the two filaments FC transported inside the body 72, and transports the twisted filament FB through the delivery port 72b toward the applying unit 20.

In the exemplary embodiment, the pair of through tubes 74a rotate in a clockwise direction as viewed from the upstream in the transport direction of the filaments FC, so that the two filaments FC are twisted to form the twisted filament FB. That is, the twisted filament FB according to the exemplary embodiment is an S-twist filament twisted in the right-handed direction. In the exemplary embodiment, the twisted filament FB is formed by twisting the two filaments FC formed from the fiber bundle FD impregnated with the resin R. That is, in the exemplary embodiment, the twisted filament FB includes 6000 carbon fibers. The twisting mechanism 74 is not limited to the one including the pair of through tubes 74a.

### (Untwisting Unit)

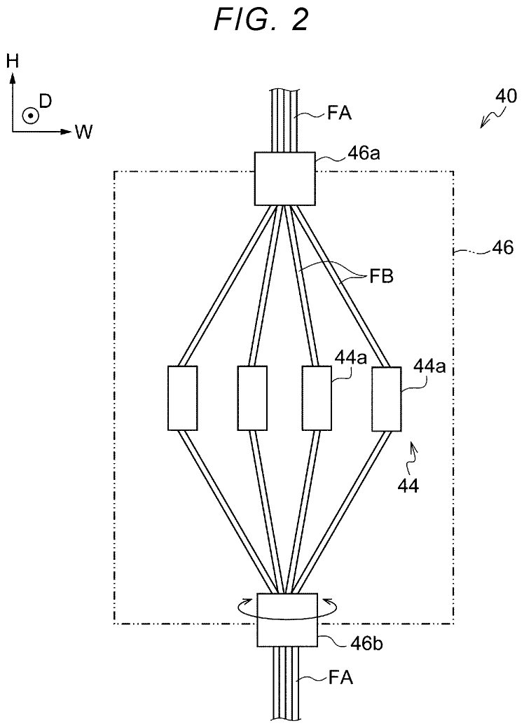

As shown in FIG. 1, the untwisting unit 40 is provided between the filament heating unit 22 and the angle change roller 26. As shown in FIG. 2, the untwisting unit 40 includes a body 46 and an untwisting mechanism 44. The body 46 is a container-shaped member in which the untwisting mechanism 44 is accommodated. The body 46 has a receiving port 46a and a delivery port 46b. The body 46 receives the parallel filament FA transported from the parallel transport unit 30 through the receiving port 46a. The receiving port 46a divides the received parallel filament FA into four twisted filaments FB and transports the four twisted filaments FB to the untwisting mechanism 44. The delivery port 46b arranges the four twisted filaments FB from the receiving port 46a via the untwisting mechanism 44 in parallel again to form the parallel filament FA, and then sends out the parallel filament FA toward the angle change roller 26 through the delivery port 46b.

The body 46 electrically connects the controller 42 (see FIG. 1) to the untwisting mechanism 44. In the body 46, the delivery port 46b is rotatable about the central axis of the parallel filament FA. When the applying unit 20 applies the parallel filament FA while the parallel filament FA is curved and moved along the surface a of the base 14 based on shaping process data of the three-dimensional object, the body 46 rotates the delivery port 46b in accordance with movement of the applying unit 20. A rotation angle of the delivery port 46b is controlled by the overall controller (not shown).

### (Untwisting Mechanism)

The untwisting mechanism 44 includes, for example, four untwisting tubes 44a which are cylindrical members extending in the transport direction of the twisted filament FB. Each of the four twisted filaments FB transported from the filament manufacturing devices 50 is passed inside a corresponding one of the four untwisted tubes 44a. In the exemplary embodiment, the untwisting mechanism 44 rotates the untwisting tubes 44a about central axes of the untwisting tubes 44a in a counterclockwise direction as viewed from above, so as to untwist the twisted filaments FB transported inside the untwisting tubes 44a. That is, the untwisting unit 40 untwists the fiber bundles FD of each of the twisted filament FB forming the parallel filament FA by the untwisting mechanism 44. The controller 42 controls an amount of untwisting by which the untwisting unit 40 untwists the twisted filaments FB.

The twisted filament FB untwisted by the untwisting mechanism 44 and applied from the applying unit 20 while being relatively moved with respect to the base 14 can extend more along a moving direction of the applying unit 20 than the twisted filament FB that is not untwisted.

The untwisting mechanism 44 is not limited to the one including the four untwisting tubes 44a.

(Process of Shaping Layer including Folded Portion)

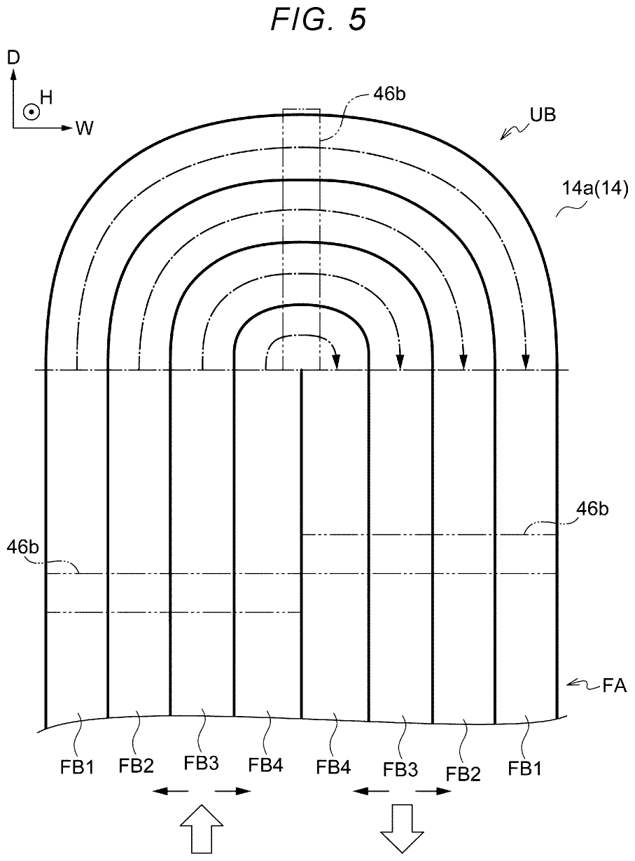

Next, a process of shaping a layer including a folded portion UB curved in a U shape along the surface 14a of the base 14 will be described with reference to FIG. 5. The folded portion UB is an example of a curved portion.

First, the applying unit 20 applies the parallel filament FA toward the surface 14a of the base 14 while being relatively moved with respect to the surface 14a along the surface 14a by the moving unit 16 in accordance with the shaping process data of the three-dimensional object to be shaped. The twisted filaments FB forming the parallel filament FA applied to the base 14 are FB1, FB2, FB3, and FB4 in order from a left side as viewed from an upstream in a moving direction of the applying unit 20 relative to the base 14.

Description will be made on a case where in the folded portion UB, a rotation controller (not shown) rotates the delivery port 46b clockwise by 180° as viewed from above, and the applying unit 20 applies the parallel filament FA while being turned 180° back and moved to a right side by the moving unit 16. At this time, a path length of the twisted filament FB1 located on an outer circumference side of the folded portion UB is longer than a path length of the twisted filament FB2 located on an inner circumference side of the folded portion UB with respect to the twisted filament FB1. At this time, the path length of the twisted filament FB2 is longer than a path length of the twisted filament FB3 located on an inner circumference side of the folded portion UB with respect to the twisted filament FB2. At this time, the path length of the twisted filament FB3 is longer than a path length of the twisted filament FB4 located on the inner circumference side of the folded portion UB with respect to the twisted filament FB3.

The controller 42 knows the path length of each of the twisted filaments FB1 to FB4 in the folded portion UB based on the shaping process data of the three-dimensional object before the parallel filament FA is applied to the folded portion UB.

Then, the controller 42 controls the untwisting unit 40 based on the path lengths of the twisted filaments FB1 to FB4 in the folded portion UB to untwist the twisted filaments FB1 to FB4, separately. Specifically, the amount of untwisting by which the twisted filament FB3 located on the outer circumference side of the folded portion UB with respect to the twisted filament FB4 is untwisted is larger than an amount of untwisting by which the twisted filament FB4 is untwisted. An amount of untwisting by which the twisted filament FB2 located on the outer circumference side of the folded portion UB with respect to the twisted filament FB3 is untwisted is larger than the amount of untwisting by which the twisted filament FB3 is untwisted. An amount of untwisting by which the twisted filament FB1 located on the outer circumference side of the folded portion UB with respect to the twisted filament FB2 is untwisted is larger than the amount of untwisting by which the twisted filament FB2 is untwisted.

At this time, the twisted filament FB4 located on the innermost circumference of the folded portion UB is untwisted based on the path length in the folded portion UB. The twisted filament FB4 located on the innermost circumference of the folded portion UB may not be untwisted. In particular, when a folding radius of the folded portion UB is small or when the folded portion UB is suddenly folded, the twisted filament FB4 located on the innermost circumference of the folded portion UB may not be untwisted.

### (Effect)

Next, an effect of the exemplary embodiment will be described. In description on a comparative example with respect to the exemplary embodiment, when the same components and the like as those of the shaping apparatus 10 according to the exemplary embodiment are used, numerals and names of the components and the like are used as they are.

The filament manufacturing device 50 according to the exemplary embodiment includes the twisting unit 70 that twists the filaments FC downstream of the impregnation unit 60 in the transport direction of the fiber bundles FD. Therefore, the filament manufacturing device 50 can manufacture the filaments FB each formed by twisting the filaments FC which are the fiber bundles FD impregnated with the resin R.

In the filament manufacturing device 50 according to the exemplary embodiment, the impregnation unit 60 includes the impregnation roller group 66. Therefore, in the filament manufacturing device 50, a variation in the amount of the resin R, with which the continuous fibers are impregnated, is prevented as compared with a configuration in which the continuous fibers in a bundled state are impregnated with the resin R.

In the filament manufacturing device 50 according to the exemplary embodiment, the twisting unit 70 is supplied with the two filaments FC and twists the two supplied filaments FC to form the twisted filament FB. Therefore, the filament manufacturing device 50 has a large amount of continuous fibers per unit length of the formed filament, as compared with a configuration in which a bundle of continuous fibers is twisted to form a filament.

The shaping apparatus 10 according to the exemplary embodiment includes the untwisting unit 40 that untwists twists of the fiber bundles FD of each of the twisted filaments FB forming the parallel filament FA. Therefore, the shaping apparatus 10 may change a length of each of plural twisted filaments applied in parallel by untwisting the plural twisted filaments.

The shaping apparatus 10 according to the exemplary embodiment includes the controller 42. The controller 42 performs control such that when the applying unit 20 applies the parallel filament FA in the folded portion UB, the amount of untwisting by which the twisted filament on the outer circumference side of the folded portion UB is untwisted is larger than the amount of untwisting by which the twisted filament on the inner circumference side of the folded portion UB is untwisted. With respect to the shaping apparatus 10, a shaping apparatus of a first comparative example is configured such that the amount of untwisting by which the twisted filament on the outer circumference side of the folded portion UB is untwisted is equal to the amount of untwisting by which the twisted filament on the inner circumference side of the folded portion UB is untwisted.

When the applying unit 20 applies the parallel filament FA in the folded portion UB, the path length of the twisted filament on the outer circumference side of the folded portion UB is larger than the path length of the twisted filament on the inner circumference side of the folded portion UB. Therefore, in the first comparative example in which the amount of untwisting by which the twisted filament applied to the outer circumference side of the folded portion UB is untwisted is equal to the amount of untwisting by which the twisted filament applied to the inner circumference side of the folded portion UB is untwisted, elongation of the twisted filament applied to the outer circumference side of the folded portion UB caused by the untwisting may be insufficient. When the elongation of the twisted filament on the outer circumference side caused by the untwisting is insufficient, the filament may be applied closer to the inner circumference side with respect to a target position.

On the other hand, in the shaping apparatus 10 according to the exemplary embodiment, the twisted filaments FB1 to FB4 forming the parallel filament FA applied to the folded portion UB are untwisted by the controller 42 in accordance with the respective path lengths. Accordingly, the shaping apparatus 10 according to the exemplary embodiment may apply the parallel filament FA in accordance with a shape of the folded portion UB. Therefore, according to the shaping apparatus 10, shape accuracy of the folded portion UB to be shaped is improved as compared with the configuration in which the amount of untwisting by which the twisted filament on the outer circumference side of the folded portion UB is untwisted is equal to the amount of untwisting by which the twisted filament on the inner circumference side of the folded portion UB is untwisted. It is noted that the technical concepts of the present disclosure cover the first comparative example.

In the shaping apparatus 10 according to the exemplary embodiment, the parallel transport unit 30 arranges the four twisted filaments FB each formed by twisting the two fiber bundles FD impregnated with the resin R, in parallel and sends the four twisted filaments FB as the parallel filament FA. Therefore, in which the shaping apparatus 10 can change the lengths of the applied twisted filaments FB by untwisting in a broad range, as compared with a configuration in which the twisted filament formed by twisting one bundle of continuous fibers is applied.

The specific exemplary embodiment of the present disclosure has been described above in detail. It is noted that the present disclosure is not limited to the exemplary embodiment. Various modifications, changes, and improvements may be made within the scope of the technical idea of the present disclosure.

For example, in the exemplary embodiment, the twisted filament FB is formed by the pair of through tubes 74a, through which the two filaments FC are passed, rotating about the central axis of the body 72 of the twisting unit 70. However, the through tubes 74a may twist the filaments FC by rotating about the central axes of the through tubes 74a while rotating about the central axis of the body 72. At this time, the fiber bundles FD that form the filaments FC and are impregnated with the resin R have twist due to the twisting.

In the exemplary embodiment, the twisted filament FB is formed by twisting two filaments FC. Alternatively, in the present disclosure, the twisted filament FB may be formed by twisting three or more filaments FC. Further alternatively, in the present disclosure, the twisted filament FB may be a fiber bundle FD that is impregnated with the resin R and that has twist formed by twisting the fiber bundle itself.

In the exemplary embodiment, the parallel filament FA is formed by arranging the four twisted filaments FB in parallel. Alternatively, in the present disclosure, the number of the twisted filaments FB forming the parallel filament FA may be two, three, or five or more.

In the exemplary embodiment, the twisted filaments FB are S-twist ones. Alternatively, in the present disclosure, the twisted filaments FB may be Z-twist ones.

In the exemplary embodiment, the untwisting unit 40 untwists the twisted filament FB formed by twisting the two filaments FC. Alternatively, in the present disclosure, the untwisting unit 40 may untwist one twisted filament FB having twist formed by twisting the fiber bundle FD itself.

In the exemplary embodiment, the folded portion UB is an example of a curved portion. It is noted that the curved portion according to the present disclosure is not limited to the folded portion UB. Specifically, the curved portion may include plural folded portions in a shaping process in which a shaping material is applied in a zigzag shape on a flat surface to form a layer. The curved portion may also include a curve forming the shaping process for forming a layer by applying the shaping material in a spiral shape on the flat surface.

In the exemplary embodiment, the untwisting unit 40 is provided downstream of the filament heating unit 22 in the transport direction of the fiber bundle FD. Alternatively, the untwisting unit 40 may be provided upstream of the filament heating unit 22 in the transport direction of the fiber bundle FD.

Although not specifically described in the exemplary embodiment, the twisted filaments FB formed by the filament manufacturing device 50 may be stored and used in different applications. The stored twisted filaments FB may be supplied to a shaping apparatus that includes no filament manufacturing device 50, to form a three-dimensional object.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A filament manufacturing device comprising:
an impregnation unit configured to impregnate a bundle of transported continuous fibers with a resin so as to form a filament; and
a twisting unit configured to twist the filament downstream of the impregnation unit in a transport direction in which the bundle of continuous fibers is transported, so as to form the twisted filament.

2. The filament manufacturing device according to claim 1, wherein the impregnation unit comprises an opening unit configured to open the bundle of continuous fibers.

3. The filament manufacturing device according to claim 1, wherein the twisting unit is supplied with a plurality of the filaments and twists the plurality of supplied filaments to form the twisted filament.

4. The filament manufacturing device according to claim 2, wherein the twisting unit is supplied with a plurality of the filaments and twists the plurality of supplied filaments to form the twisted filament.

5. A shaping apparatus comprising:
a parallel transport unit configured to
arrange a plurality of twisted filaments each formed by twisting a bundle of continuous fibers impregnated with a resin, in parallel, and
transport the plurality of twisted filaments;
a filament heating unit configured to heat the plurality of twisted filaments arranged in parallel and transported by the parallel transport unit;
an applying unit configured to apply the plurality of twisted filaments, which are heated by the filament heating unit and arranged in parallel, on an applied surface while relatively moving with respect to the applied surface along the applied surface; and
an untwisting unit disposed upstream of the applying unit in a direction in which the twisted filaments are sent, the untwisting unit being configured to untwist a twist of the bundle of continuous fibers in each of the twisted filaments arranged in parallel.

6. The shaping apparatus according to claim 5, further comprising:
a controller configured to control the untwisting unit such that, when the applying unit applies the plurality of twisted filaments arranged in parallel while the twisted filaments arranged in parallel are curved in a direction along the applied surface, an amount of untwisting by which the untwisting unit untwists a twisted filament on an outer circumference side of a curved portion is larger than an amount of untwisting by which the untwisting unit untwists a twisted filament on an inner circumference side of the curved portion.

7. The shaping apparatus according to claim 5, wherein
the parallel transport unit arranges, as the twisted filaments, a plurality of twisted filaments formed by twisting a plurality of bundles of continuous fibers impregnated with the resin in parallel and transports the plurality of twisted filaments.

8. The shaping apparatus according to claim 6, wherein
the parallel transport unit arranges, as the twisted filaments, a plurality of twisted filaments formed by twisting a plurality of bundles of continuous fibers impregnated with the resin in parallel and transports the plurality of twisted filaments.

9. A filament manufacturing device comprising:
impregnation means for impregnating a bundle of transported continuous fibers with a resin so as to form a filament; and
twisting means for twisting the filament downstream of the impregnation means in a transport direction in which the bundle of continuous fibers is transported, so as to form the twisted filament.
